(19) United States
(12) Patent Application Publication
(10) Pub. No.: US 2009/0214038 A1
(43) Pub. Date: Aug. 27, 2009

(54) SECURITY-ENHANCED RFID SYSTEM

(76) Inventors: Chien Yaw Wong, Cambridgeshire (GB); Da Xing, Cambridgeshire (GB); Duncan McFarlane, Cambridgeshire (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/091,262

(22) PCT Filed: Oct. 24, 2006
(86) PCT No.: PCT/GB2006/050350

§ 371 Date: Oct. 13, 2008

(30) Foreign Application Priority Data
Oct. 24, 2005 (GB) 0521613.0

(51) Int. Cl. H04K 1/00; H04L 9/30

(52) U.S. Cl. 380/270; 380/30

(57) ABSTRACT

The present invention relates to RFID systems. In particular, the invention relates to an RFID system having enhanced security of communication between a tag and a tag reader. In a first aspect of the present invention there is provided an RFID system comprising at least one RFID reader; control means for communicating with an RFID tag by public-key encryption via said reader; at least one RFID tag adapted to encrypt a response to a transmission by a reader using a public-key transmitted to the tag; unauthorised broadcast detection means for detecting a broadcast made by an unauthorised reader; and alert means for providing an alert in the event a broadcast by an unauthorised reader is detected.

The present invention relates to Radio Frequency Identification (RFID) systems, and in particular to RFID systems having improved security.

### BACKGROUND

RFID systems rely on radio frequency-based communication between a reader or interrogator and a transponder or tag of various types for the purpose of identifying objects in a wide range of applications. However, this communication can be easily intercepted if it follows an open standard communication protocol. For example, an unauthorised reader could passively listen to communications between an authorized reader and tags and interpret these following the open standard. Alternatively, the unauthorised reader could actively query the tag following the open standard. This is not desirable in cases where privacy and security of information are important. It is therefore desirable to prevent the unauthorized reader from intercepting and interpreting communications from the tags, even when such communications follow an open standard protocol. Furthermore, in cases where an unauthorized reader transmits an active query to the tag, it would be desirable to be able to detect such an activity, and where appropriate, to alert security personnel to this situation.

It is known from EP 0 853 288 to address this issue by providing an encryption key (or keys) for the tags and storing the key(s) in a database. Only authorized readers have access to the key(s) and are thus able to decrypt information sent by a tag. However, the encryption key is static and permanently stored in the database, making it inflexible to use in some applications. For example, in supply chain applications, products associated with tags are moved, from time to time, to different locations such as a different company or a different country. EP 0 853 288, if implemented, also requires the transfer of the encryption key of each tag to those locations. The required database connectivity for such a transfer may not be present, or at least not continually present. Furthermore, a unique key needs to be created for each tag, and thus a large overhead cost is associated with maintaining these keys. This clearly adds a further level of complexity to the system. Another weakness of this approach is that if the security of one of the sites is breached and the database keys become known, the security of the entire chain is at risk.

In a first aspect of the present invention there is provided an RFID system comprising: at least one RFID reader; control means for communicating with an RFID tag by public-key encryption via said reader; at least one RFID tag adapted to encrypt a response to a transmission by a reader using a public-key transmitted to the tag; detection means for detecting a broadcast made by an unauthorised reader; and alert means for providing an alert in the event a broadcast by an unauthorised reader is detected.

The present invention has the advantage that an operator of an RFID system may be alerted to the presence of an unauthorised RFID reader in the event that an unauthorised reader makes an RF transmission.

Preferably the system further comprises key generator means for generating a new public-key/private-key pair for said public key encryption, said reader being adapted to transmit said new public-key to a tag.

Since the tag responds to a reader using the public key supplied by the tag, it is not necessary for the tag to be pre-programmed with a security key corresponding to a security key of the reader. Similarly, it is not necessary for the reader to be pre-programmed or supplied with a security key corresponding to a security key of the tag. Thus, if a tag is moved between geographical locations, a reader in a second location can initiate communication using a freshly generated public key bearing no relation to a public key used to communicate between a reader and a tag at a first location. This feature therefore greatly enhances the flexibility of the system.

Furthermore, this feature enhances the security of the system, since an unauthorised reader having obtained the public-key/private-key pair in an unauthorised manner would be able to communicate with a tag and therefore obtain potentially valuable information from the tag, such as bank account or credit card information. By changing the public-key/private-key pair, the unauthorised reader will be required to obtain the new private-key before it can decode a transmission by a tag.

Preferably, the key generator means is adapted to generate said new public-key/private-key pair for each transmission by a reader.

This has the advantage that a new private-key must be known by an unauthorised reader in the case of each communication by a tag, if the unauthorised reader is to be able to decrypt each communication by a tag.

Alternatively, the key generator means may be adapted to generate said new public-key/private-key pair at random or pseudo-random intervals of time. In a further alternative, the key generator means may be adapted to generate said new public-key/private-key pair at predetermined intervals of time, which may be regular intervals of time or any other appropriate intervals.

These embodiments have the advantage that new public-key/private-key pairs do not have to be generated prior to each communication by a reader. They may be particularly useful in systems having a plurality of readers communicating with a large number of tags. The time taken to generate a new public-key/private-key pair and transmit it to a reader via the secured network may be sufficient to reduce the maximum frequency of reader: tag communications, thereby reducing the maximum communication rate.

In a still further alternative, the key generator means may be adapted to generate said new public-key/private-key pair in response to an external trigger.

For example, the external trigger might be the detection of an unauthorised reader by the detection means. This feature has the advantage that if an unauthorised reader is detected, the public-key/private-key pair can be regenerated in case the unauthorised reader succeeds in decrypting a message encrypted according to the public-key. An external trigger might be a push-button, mechanical switch, TTL pulse or a digital command send by a wired or wireless connection.

Thus, by transmitting the new public-key to the tag by a reader, the public-key used by the tag can be updated automatically in a relatively simple manner. Updating the public-key in this manner therefore does not require the replacement of any physical component of the tag, nor does it require the tag to be physically connected to a device for reprogramming with the new public-key.

Preferably, the RFID reader is adapted to transmit said public-key of said new public-key/private-key pair to a tag.

The reader may transmit the public-key as soon as a new public-key/private-key pair is generated. Alternatively or in addition the reader may transmit the public-key with a communication to a tag.

Preferably, the unauthorised broadcast detection means comprises means for determining whether a received RF broadcast comprises a public-key that does not correspond to a public key stored in the RFID system.

Thus, in the event that an unauthorised reader commences communication with a tag by broadcasting a message containing a public-key that does not correspond to a public key stored in the system at that moment, the RFID system will detect that the reader is an unauthorised reader.

Preferably the means for determining whether a received RF broadcast is encrypted according to a public-key that does not correspond to a public key stored in the RFID system comprises means for attempting to decrypt said RF broadcast received, and means for determining whether said attempt was successful.

The system may be further provided with locating means for detecting a location of an unauthorised reader

This has the advantage that measures may be taken to deactivate the unauthorised reader, or move the unauthorised reader from the system environment.

The locating means may be triggered by said alert. Thus, in the event that an alert is generated, the locating means is triggered to attempt to locate the unauthorised reader.

Preferably the system further comprises an RFID tag, the tag being adapted to communicate with said at least one reader by public-key encryption.

The system may comprise at least two RFID readers that communicate with each other by way of public-key encryption. Thus, secure communication between readers is possible. In this manner, a public-key/private-key pair could be distributed securely between readers of the system without requiring a separate network connection.

In a second aspect of the invention there is provided a method of communication between at least one RFID reader and at least one RFID tag of an RFID system according to the first aspect of the invention, comprising the steps of: a. providing a public-key/private-key pair to a controller; b. transmitting a message comprising said public-key from said at least one RFID reader to said at least one RFID tag; c. receiving a reply from said at least one tag encrypted according to said public-key; and d. decrypting said reply from said tag, wherein the method further comprises the steps of e. monitoring RFID transmissions in an area; and f. detecting a broadcast by an unauthorised reader; and g. providing an alert in the event a transmission is detected by an unauthorised RFID reader.

Preferably, step (a) further comprises the step of generating a new public-key/private-key pair at predetermined intervals of time, to be provided to said controller.

Alternatively, step (a) may further comprises the step of generating a new public-key/private-key pair at random intervals of time, to be provided to said controller.

In a still further alternative, step (a) further comprises the step of generating a new public-key/private-key pair prior to each transmission by a reader. Such a step might be implemented in environments where the most secure communications are required.

Step (a) may comprise the step of generating a new public-key/private-key pair in response to an external trigger. Thus, in the event that an unauthorised reader is detected, a new public-key/private-key pair may be generated.

The step of detecting a broadcast by an unauthorised reader may further comprise the step of determining whether a received RF broadcast comprises a public-key that does not correspond to a public-key stored in the RFID system.

Alternatively or in addition, the step of detecting a broadcast by an unauthorised reader may comprise the step of determining whether a received RF broadcast is encrypted according to a public-key that does not correspond to a public-key stored in the RFID system.

The step of determining whether a received RF broadcast is encrypted according to a public-key that does not correspond to a public key stored in the RFID system may comprise the step of making an attempt to decrypt said RF broadcast received, and determining whether said attempt was successful.

Embodiments of the present invention make use of transient encryption key(s) issued at the application level. Details of the fundamentals are described below.

Embodiments of the present invention may further comprise communication to, with or from additional RFID readers or, more generally, devices, including readers, Bluetooth® devices, WiFi routers, access points etc., either by way of controllers as disclosed in UK patent application no 0615892.7 due to the present applicant, or by some other means such as RFID air interface, WiFi, Bluetooth®, Ethernet etc.

These communications between RFID readers (or, more generally, communication between an RFID reader and a “device”) could be used to improve performance of the RFID systems disclosed herein, for example by reducing reader collisions or other problems, or RFID reader configuration set-up, communication between two unconnected networks, reader identification etc. These communications may be secure, as described in the present application, or unsecured.

For a better understanding of the present invention, and to show how it may be carried into effect, reference shall now be made by way of example to the accompanying drawing, in which:

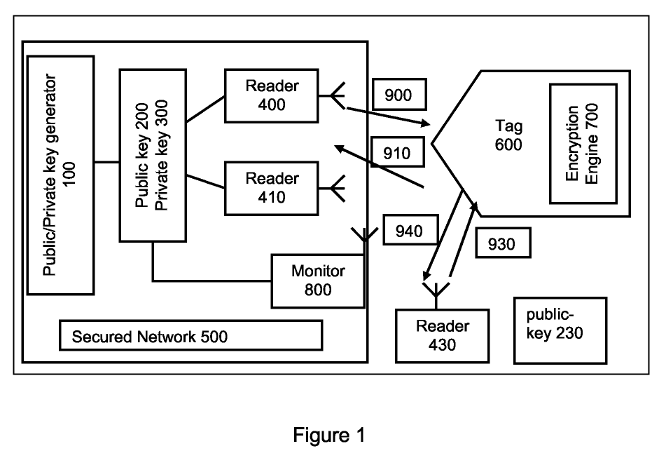

FIG. 1 is a schematic illustration of the components of an RFID system according to a preferred embodiment of the present invention.

In a preferred embodiment of the present invention, authorised readers 400 and 410 are readers authorized to read tags 600, and unauthorised reader 430 is a reader not authorized to read tags 600. Authorised readers 400, 410 comprise a digital signal processor (DSP), an RF Front end and a logic block (or controller).

There are two ways in which an unauthorized reader 430 could obtain information from a tag 600. The unauthorised reader 430 could “listen to” or intercept communication between authorized readers and tags, or alternatively it could directly query a tag 600. Moreover, a tag 600 equipped with an encryption engine 700 might reply to any query submitted without a public key. A direct query to a tag 600 could request the tag to reply in a non-encrypted form, or in an encrypted form using a public key 230 provided by the unauthorised reader 430. Public-key 200 is calculated such that the chance that public-key 200 provided by an authorised reader 400, 410 is identical to the public-key 230 provided by an unauthorised reader 430 is very small, using well-known modern encryption methodologies.

The invention addresses these scenarios by an asymmetric encryption approach using public/private key pairs 200/300.

The system comprises a secured network 500 interconnecting one or more authorised tag readers 400, 410 and a monitor 800 to a system controller. One or more tags 600 are also provided, programmed to communicate with the tag readers 400, 410 by an asymmetric public-key encryption protocol. A tag 600 has an encryption engine 700 which encrypts the data to be transmitted to a reader 400, 410 using a public key 200 provided by a reader 400, 410. The monitor 800 listens to authenticated reader transmissions 900 and tag responses 910, and to unauthenticated reader transmissions 930 and unauthorised tag responses 940 between an unauthenticated reader 430 and tags 600.

The system controller comprises a key generator 100 which generates a public-key/private-key pair 200/300. The key generator 100 communicates the public-key/private-key pair 200/300 to each authenticated reader 400, 410 and to the monitor 800 via the secured network 500.

In the present embodiment the secured network 500 comprises an Ethernet connection. In alternate embodiments the secured network 500 comprises a wireless network or other forms of secured communication layer.

In the present embodiment of the invention the key generator 100 is housed separately from the authorised readers 400, 410. In alternate embodiments the key generator 100 is comprised as part of an authorised reader 400, 410. Similarly, authorised readers 400, 410 may communicate directly with one another via a separate secure and encrypted wired or wireless network.

To maintain the security of the system it is important that the private key 300 is contained within the secured network 500 and is not available outside the network 500. This is to prevent an unauthorised reader 430 from decrypting tag transmissions 910 encrypted using the public-key 200.

When a reader 400, 410 communicates with a tag 600, for example requesting information from a tag 600 in a reader transmission 900, the reader 400, 410 transmits the public-key as part of the reader transmission 900 to the tag 600. The tag 600 is programmed to transmit a tag response 910 to the reader 400, 410, the tag response 910 being encrypted by the encryption engine 700 of the tag 600 according to the public-key 200 received from the reader 400, 410. Upon receiving the response 910, the authenticated readers 400, 410 can use the securely distributed private-key 300 to decrypt the tag response 910. However, since the private-key 200 is not accessible to equipment that is not connected to the secured network 500, an unauthorised tag reader 430 is incapable of decrypting the tag response 910.

In one embodiment of the invention the key generator 100 generates a new public-key/private-key pair 200/300 at random or pseudorandom intervals of time and transmits the new pair 200/300 to each authenticated reader 400, 410 for use in subsequent transmissions 900 in alternate embodiments the key generator 100 generates a new public-key/private-key pair 200/300 at predetermined intervals of time. In still further embodiments, the key generator 100 generates a new public-key/private-key pair 200/300 in response to an external trigger.

If an unauthenticated reader 430 communicates with a tag 600 using an unauthorised public-key of an unauthorised public-key/private-key pair, the tag 600 will reply with an encrypted message using the unauthorised public key. The unauthenticated reader 430 will be able to decrypt the information from the tag if it is in possession of the corresponding private-key, however the monitor 800 will most likely be unable to decrypt the message since it will not be in possession of the corresponding private-key.

The monitor will therefore detect that an unauthorised reader is active and raise an alarm. The alarm may be an audible alarm, a visual alarm, a computer message, and/or any other suitable alarm.

In one embodiment of the invention the triggering of the alarm also triggers a location detection system to detect the location of the unauthorised reader 430. One possible location detection system determines the approximate location of the unauthorized reader 430 making an active query (with the tag responding) as follows:
1. Monitor 800 detects an active query 930 of the unauthorized reader 430 and the corresponding tag reply 940.
2. If 930 is not accompanied by the public key 230, the tag reply 940 will be unencrypted. The system could query its record to find which authorized reader could read the tag 600. For example, if the authorized reader 400 has the latest record of tag 600, therefore, the unauthorized reader 430 must be in the vicinity of reader 400.
3. If the monitor 800 detects that active query 930 has a public key 230, then monitor 800 will know that the response from the tag 940 will be encrypted. The system could then instruct the authorised readers to broadcast a query using public key 230 and determine which authorized reader will receive the same encrypted reply 940. For example, if the reader 410 receives a reply identical to that of 940, then the unauthorized reader 430 must be in the vicinity of reader 410.

Either way, an inferred estimation of the location of the unauthorized reader 430 can be obtained.

If an unauthorised reader 430 makes a transmission 930 to a tag 600 using a public-key that does not correspond to a public-key 200 stored in the system, and the monitor 800 receives the transmission 930, the monitor 800 detects that a public-key is contained within the transmission 930 that does not correspond to a public-key 200 stored in the RFID system. Consequently the monitor raises an alarm, which may be an audible alarm, a visual alarm, a computer message, and/or any other suitable alarm.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. An RFID system comprising:
at least one RFID reader;
control means for communicating with an RFID tag by public-key encryption via said reader;
at least one RFID tag adapted to encrypt a response to a transmission by a reader using a public-key transmitted to the tag;
unauthorised broadcast detection means for detecting a broadcast made by an unauthorised reader; and
alert means for providing an alert in the event a broadcast by an unauthorised reader is detected.

2. The RFID system of claim 1 wherein the system further comprises key generator means for generating a new public-key/private-key pair for said public key encryption.

3. The RFID system of claim 2 wherein said key generator means is adapted to generate said new public-key/private-key pair for each transmission by a reader.

4. The RFID system of claim 2 wherein said key generator means is adapted to generate said new public-key/private-key pair at random intervals of time.

5. The RFID system of claim 2 wherein said key generator means is adapted to generate said new public-key/private-key pair at predetermined intervals of time.

6. The RFID system of claim 2 wherein said key is further adapted to generate said new public-key/private-key pair in response to an external trigger.

7. The RFID system of claim 2 wherein an RFID reader is adapted to transmit said public-key of said new public-key/private-key pair to a tag.

8. The RFID system of claim 1 wherein the unauthorised broadcast detection means comprises means for determining whether a received RF broadcast comprises a public-key that does not correspond to a public key stored in the RFID system.

9. The RFID system of claim 1 wherein the unauthorised broadcast detection means comprises means for determining whether a received RF broadcast is encrypted according to a public-key that does not correspond to a public key stored in the RFID system.

10. The RFID system of claim 9 wherein the step of determining whether a received RF broadcast is encrypted according to a public-key that does not correspond to a public key stored in the RFID system comprises means for attempting to decrypt said RF broadcast received, and means for determining whether said attempt was successful.

11. The RFID system of claim 1 wherein the system is adapted further provided with locating means for detecting a location of an unauthorised reader.

12. The RFID system of claim 11 wherein the locating means is triggered by said alert.

13. The RFID system of claim 11, wherein the unauthorised broadcast detecting means is adapted to detect a broadcast made by an unauthorised reader and also to detect a response made thereto by a tag, and wherein the locating means determines a location of the unauthorised reader by reference to a known location of an authorised reader that would elicit the same response from the tag.

14. The RFID system of claim 11, wherein the unauthorised broadcast detecting means is adapted to detect a broadcast made by an unauthorised reader with a particular public key and also to detect an encrypted response made thereto by a tag, and wherein the locating means triggers a broadcast query using the particular public key and then determines a location of the unauthorised reader by reference to a known location of an authorised reader that would elicit the same encrypted response from the tag.

15. The RFID system of claim 1 wherein the system further comprises an RFID tag, the tag being adapted to communicate with said at least one reader by public-key encryption.

16. The RFID system of claim 1 wherein the system comprises at least two RFID readers that communicate with each other by way of public key encryption.

17. The RFID system of any claim 1, further adapted to communicate with another RFID reader, system of readers, or communications device.

18. A method of communication between at least one RFID reader and at least one RFID tag of an RFID system according to claim 1, comprising the steps of:
a. providing a public-key/private-key pair to a controller;
b. transmitting a message comprising said public-key from said at least one RFID reader to said at least one RFID tag;
c. receiving a reply from said at least one tag encrypted according to said public-key; and
d. decrypting said reply from said tag,
wherein the method further comprises the steps of
e. monitoring RFID transmissions in an area; and
f. detecting a broadcast by an unauthorised reader; and
g. providing an alert in the event a transmission is detected by an unauthorised RFID reader.

19. The method of claim 18, wherein step (a) further comprises the step of generating a new public-key/private-key pair at predetermined intervals of time, to be provided to said controller.

20. The method of claim 18, wherein step (a) further comprises the step of generating a new public-key/private-key pair at random intervals of time, to be provided to said controller.

21. The method of claim 18, wherein step (a) further comprises the step of generating a new public-key/private-key pair prior to each transmission by a reader.

22. The method of claim 18, wherein step (a) comprises the step of generating a new public-key/private-key pair in response to an external trigger.

23. The method of claim 18, wherein the step of detecting a broadcast by an unauthorised reader further comprises the step of determining whether a received RF broadcast comprises a public-key that does not correspond to a public-key stored in the RFID system.

24. The method of claim 18, wherein the step of detecting a broadcast by an unauthorised reader further comprises the step of determining whether a received RF broadcast is encrypted according to a public-key that does not correspond to a public-key stored in the RFID system.

25. The method of claim 24, wherein the step of determining whether a received RF broadcast is encrypted according to a public-key that does not correspond to a public key stored in the RFID system comprises the step of making an attempt to decrypt said RF broadcast received, and determining whether said attempt was successful.

26. The method of claim 18, further comprising the step of detecting a location of the unauthorised reader.

27. The method of claim 26, wherein detection of the location of the unauthorised reader is triggered by said alert.

28. The method of claim 26, wherein a broadcast made by the unauthorised reader and also a response made thereto by a tag are detected, and wherein the location of the unauthorised reader is determined by reference to a known location of an authorised reader that would elicit the same response from the tag.

29. The method of claim 26, wherein a broadcast made by an unauthorised reader with a particular public key and an encrypted response made thereto by a tag are detected, and wherein a broadcast query is subsequently transmitted using the particular public key and the location of the unauthorised reader is determined by reference to a known location of an authorised reader that would elicit the same encrypted response from the tag.

30. The method of claim 18, further comprising a step of communicating with another RFID reader, system of readers, or communications device.

31. (canceled)

32. (canceled)
